(19) United States
(12) Patent Application Publication
(10) Pub. No.: US 2019/0141352 A1
(43) Pub. Date: May 9, 2019

(54) TILE-BASED 360 VR VIDEO ENCODING METHOD AND TILE-BASED 360 VR VIDEO DECODING METHOD

(71) Applicant: ELECTRONICS AND TELECOMMUNICATIONS RESEARCH INSTITUTE, Daejeon (KR)

(72) Inventors: Hyun Cheol KIM, Sejong (KR); Seong Yong LIM, Daejeon (KR); Joo Myoung SEOK, Seoul (KR)

(21) Appl. No.: 16/179,616

(22) Filed: Nov. 2, 2018

(30) Foreign Application Priority Data
Nov. 3, 2017 (KR) 10-2017-0146016
Nov. 2, 2018 (KR) 10-2018-0133502

(51) Int. Cl. H04N 19/597; H04N 19/119; H04N 19/177; H04N 19/184

(52) U.S. Cl. CPC H04N 19/597; H04N 19/184; H04N 19/177; H04N 19/119

(57) ABSTRACT

Disclosed is a 360 virtual reality (VR) video encoding method. A 360 virtual reality (VR) video encoding method according to the present disclosure includes: dividing the 360 VR video into a plurality of regions based on a division structure of the 360 VR video; generating an region sequence using the divided plurality of regions; generating a bitstream for the generated region sequence; and transmitting the generated bitstream, wherein the region sequence comprises regions having a same position in at least one or more frame included in the 360 VR image.

### CROSS REFERENCE TO RELATED APPLICATION

The present application claims priority to Korean Patent Application Nos. 10-2017-0146016 and 10-2018-0133502 filed Nov. 3, 2017 and Nov. 2, 2018 the entire contents of which is incorporated herein for all purposes by this reference.

### BACKGROUND OF THE INVENTION

### Field of the Invention

The present disclosure relates generally to encoding and decoding of an interactive video and, more particularly, to encoding and decoding of an interactive video such as 360 virtual reality (VR) video in which a reproduction region is changed according to a user's motion.

### Description of the Related Art

When an interactive video such as 360 virtual reality VR is served, the entire video is encoded and transmitted to the terminal, and the terminal decodes the entire video, and then only portion corresponding to the viewport where the user watches is rendered. However, when the entire video is encoded and transmitted in this way, even region of the video where the user does not watch is transmitted at a high definition, which leads to a great waste of network bandwidth.

Accordingly, there are methods used that can reduce transmission bit rate by transmitting only a part of 360 VR video capable of being watched by the user at a specific point of time.

In the 360 VR video, the reproduction region of the video has to be changed according to the user's motion. However, according to characteristics of the video encoding/decoding referring to the previous frame and the surrounding region, when there is no the previous frame or the surrounding region required to decode the current viewport, there is a problem that the viewport region cannot be decoded.

Therefore, in order to avoid such a problem, there are techniques of dividing an input video into multiple tiles and encoding each tile with a separate encoder in the related art.

In the related art, in order to independently encode and decode the tiles, as many video encoders and video decoders are required as the number of tiles. This causes an increase in cost necessary to configure the encoder. In the case of a decoder, most terminals do not support as many decoders as the number of tiles. Accordingly, there is a difficulty in providing a general-purpose service.

### SUMMARY OF THE INVENTION

It is an object of the present disclosure to provide to a 360 VR video encoding method and a 360 VR video decoding method that are capable of encoding and decoding high quality 360 VR video by dividing the 360 VR video into a plurality of regions. The object of the present disclosure also provides to encode and decode the 360 VR video without modification of the existed video encoder and video decoder.

In order to achieve the above object, according to one aspect of the present invention, there is provided a 360 virtual reality (VR) video encoding method, the method comprising: dividing the 360 VR video into a plurality of regions based on a division structure of the 360 VR video; generating a region sequence using the divided plurality of regions; generating a bitstream for the generated region sequence; and transmitting the generated bitstream, wherein the region sequence comprises regions having a same position in at least one or more frame included in the 360 VR image.

In the method of encoding a 360 VR video according to the present invention, wherein the region comprises at least one of a tile and a sub-picture.

In the method of encoding a 360 VR video according to the present invention, wherein the division structure of 360 VR image is determined on an unit of a group of pictures (GOP), wherein the generating the bitstream comprises: generating a bitstream for at least one region sequence included in the GOP.

In the method of encoding a 360 VR video according to the present invention, wherein the generating the bitstream comprises: repeatedly generating a bitstream for all the region sequences included in the GOP.

In the method of encoding a 360 VR video according to the present invention, wherein the bitstream comprises a first bitstream and a second bitstream generated from at least one region sequence included in the GOP, wherein the first bitstream and the second bitstream have different image quality.

In the method of encoding a 360 VR video according to the present invention, wherein the first bitstream is higher in image quality than the second bitstream.

In the method of encoding a 360 VR video according to the present invention, wherein the first bitstream is generated using a first video encoder, wherein the second bitstream is generated using a second video encoder different from the first video encoder.

In the method of encoding a 360 VR video according to the present invention, wherein the division structure of the 360 VR image comprises at least one of a number of the region, a position of the region, a size of the region and a frame rate of the region.

In the method of encoding a 360 VR video according to the present invention, wherein the frame rate is set that a time for generating a bitstream for all the region sequences included in the GOP is equal to a time for generating a bitstream for all frames included in the GOP. According to another aspect of the present disclosure, there is provided a 360 virtual reality (VR) video decoding method, the method comprising: receiving a bitstream encoded in an unit of a region sequence; decoding the received bitstream to obtain a plurality of regions; and rendering a video to be reproduced based on the plurality of regions, wherein the region sequence comprises regions having a same position in at least one or more frame included in the 360 VR image.

In the method of decoding a 360 VR video according to the present invention, wherein the region comprises at least one of a tile and a sub-picture.

In the method of decoding a 360 VR video according to the present invention, wherein the bitstream comprises at least two bitstreams having different image qualities, a viewport region is received a bitstream having a higher image quality than remaining regions excluding the viewport region.

In the method of decoding a 360 VR video according to the present invention, wherein the viewport region is determined based on a first frame of frames included in a group of picture (GOP).

In the method of decoding a 360 VR video according to the present invention, wherein the viewport region is updated in an unit of a GOP.

In the method of decoding a 360 VR video according to the present invention, wherein at least two bitstreams having different image qualities are decoded by one video decoder.

In the method of decoding a 360 VR video according to the present invention, wherein the rendering the video to be reproduced comprises: arranging the plurality of regions in an unit of the region sequence; wherein the arranging the plurality of regions comprises: arranging the plurality of regions in the same position as when inputting to a video encoder.

In the method of decoding a 360 VR video according to the present invention, wherein the arranging the plurality of regions comprises: repeatedly performing all the region sequences included in the GOP until the region sequence is arranged.

In the method of decoding a 360 VR video according to the present invention, further comprising: when the viewport region is changed, receiving a bitstream having a higher image quality that the remaining regions excluding the viewport region for the changed viewport region, based on at least one of the changed position and the GOP information.

In the method of decoding a 360 VR video according to the present invention, wherein the plurality of regions are divided from the 360 VR image based on a division structure of the 360 VR image, wherein the division structure of the 360 VR image comprises at least one of a number of the region, a position of the region, a size of the region and a frame rate of the region.

In the method of decoding a 360 VR video according to the present invention, wherein the frame rate is set that a time for generating a bitstream for all the region sequences included in a group of picture (GOP) is equal to a time for generating a bitstream for all frames included in the GOP.

The 360 VR video encoding method and the 360 VR video decoding method according to embodiments of the present invention can encode and decode the 360 VR video based on a tile or a sub-picture without using multiple video encoder or the video decoders.

Also, the 360 VR video encoding method and the 360 VR video decoding method according to embodiments of the present invention can be applied regardless of existing video encoding methods such as H.264, High Efficiency Video encoding HEVC, etc.

Further, in the 360 VR video encoding method and the 360 VR video decoding method according to embodiments of the present invention, since each region is encoded without spatial correlation, the reproduction is enabled even though only a part of each region is transmitted. Accordingly, it is possible to provide smooth rendering with only two video encoders using low quality bitstream and high quality bitstream. In particular, the number of video encoders is the same even though a large number of clients are connected, and the video encoder can be applied irrespective of a type of codec.

In addition, according to the 360 VR video encoding method and the 360 VR video decoding method of the present invention, the encoding function is embedded in a graphic card to allow high-speed video encoding and decoding to be performed even in a recent personal computer (PC), whereby it is possible to contribute in expanding individual broadcasting up to the 360 VR region.

### BRIEF DESCRIPTION OF THE DRAWINGS

The above and other objects, features, and other advantages of the present invention will be more clearly understood from the following detailed description when taken in conjunction with the accompanying drawings, in which:

FIG. 1 is a conceptual diagram illustrating tile-based 360 VR video encoding and decoding processes in a 360 VR system according to an embodiment of the present invention;

FIG. 2 is a conceptual diagram illustrating in more detail a tile-based 360 VR video encoding process according to an embodiment of the present invention;

FIG. 3 is a conceptual diagram illustrating in more detail a tile-based 360 VR video decoding process according to an embodiment of the present invention;

FIG. 4 is a conceptual diagram illustrating a tile-based 360 VR video encoding process using two video encoders according to another embodiment of the present invention;

FIG. 5 is a conceptual diagram illustrating a tile-based 360 VR video decoding process using two encoders according to another embodiment of the present invention;

FIG. 6 is a conceptual diagram showing viewport regions 512 in the frames F0, F1, . . . , F29, F30, F31, . . . , and F59 in accordance with movements of the user's head or eyes in the tile-based 360 VR video decoding process of FIG. 5;

FIG. 7 is a flowchart illustrating a tile-based 360 VR video encoding process in a 360 VR system according to an embodiment of the present invention; and

FIG. 8 is a flowchart illustrating a tile-based 360 VR video decoding process in a 360 VR system according to an embodiment of the present invention.

### DETAILED DESCRIPTION OF THE INVENTION

Hereinbelow, exemplary embodiments of the present disclosure will be described in detail such that the ordinarily skilled in the art would easily understand and implement an apparatus and a method provided by the present disclosure in conjunction with the accompanying drawings. However, the present disclosure may be embodied in various forms and the scope of the present disclosure should not be construed as being limited to the exemplary embodiments.

In describing embodiments of the present disclosure, well-known functions or constructions will not be described in detail when they may obscure the spirit of the present disclosure. Further, parts not related to description of the present disclosure are not shown in the drawings and like reference numerals are given to like components.

In the present disclosure, it will be understood that when an element is referred to as being “connected to”, “coupled to”, or “combined with” another element, it can be directly connected or coupled to or combined with the another element or intervening elements may be present therebetween. It will be further understood that the terms “comprises”, “includes”, “have”, etc. when used in the present disclosure specify the presence of stated features, integers, steps, operations, elements, components, and/or combinations thereof but do not preclude the presence or addition of one or more other features, integers, steps, operations, elements, components, and/or combinations thereof.

It will be understood that, although the terms “first”, “second”, etc. may be used herein to describe various elements, these elements should not be limited by these terms. These terms are only used to distinguish one element from another element and not used to show order or priority among elements. For instance, a first element discussed below could be termed a second element without departing from the teachings of the present disclosure. Similarly, the second element could also be termed as the first element.

In the present disclosure, distinguished elements are termed to clearly describe features of various elements and do not mean that the elements are physically separated from each other. That is, a plurality of distinguished elements may be combined into a single hardware unit or a single software unit, and conversely one element may be implemented by a plurality of hardware units or software units. Accordingly, although not specifically stated, an integrated form of various elements or separated forms of one element may fall within the scope of the present disclosure.

In the present disclosure, all of the constituent elements described in various embodiments should not be construed as being essential elements but some of the constituent elements may be optional elements. Accordingly, embodiments configured by respective subsets of constituent elements in a certain embodiment also may fall within the scope of the present disclosure. In addition, embodiments configured by adding one or more elements to various elements also may fall within the scope of the present disclosure.

Hereinbelow, exemplary embodiments of the present disclosure will be described in detail with reference to the accompanying drawings. Throughout the drawings, the same reference numerals will refer to the same or like parts.

A viewport is a region watched by a user of the total video and may be defined as a part of a spherical video currently displayed, which is watched by the user.

A method of dividing a 360 VR video into a plurality of regions and generating/parsing a bitstream for each unit region will be described in the following embodiments. Here, the division unit of the 360 VR video projected on the 2D plane may be a sub-picture, a tile, or the like. The divided regions may have an equal size or may have different sizes. As an example, the size of any one of the divided regions may have a different size from the other regions. Alternatively, a size, a height or a width of each region may be set to have an equal size. The size may comprise a width, a length, a diagonal length of the region, or a length at a predetermined position of the region.

In the present invention, a set of spatial regions at the same position in each of the frames may be defined as a ‘set’ or ‘sequence’. For example, the region set or region sequence may refer to a set of spatial regions having a same position in a plurality of frames.

In the following embodiment, it is assumed that the 360 VR video is divided into a plurality of tiles. In addition, it is assumed that each tile has the same size. However, it is apparent that the embodiment described below can also be applied to a case where the division unit of the 360 VR video is a sub-picture or when the size of each tile is not uniform.

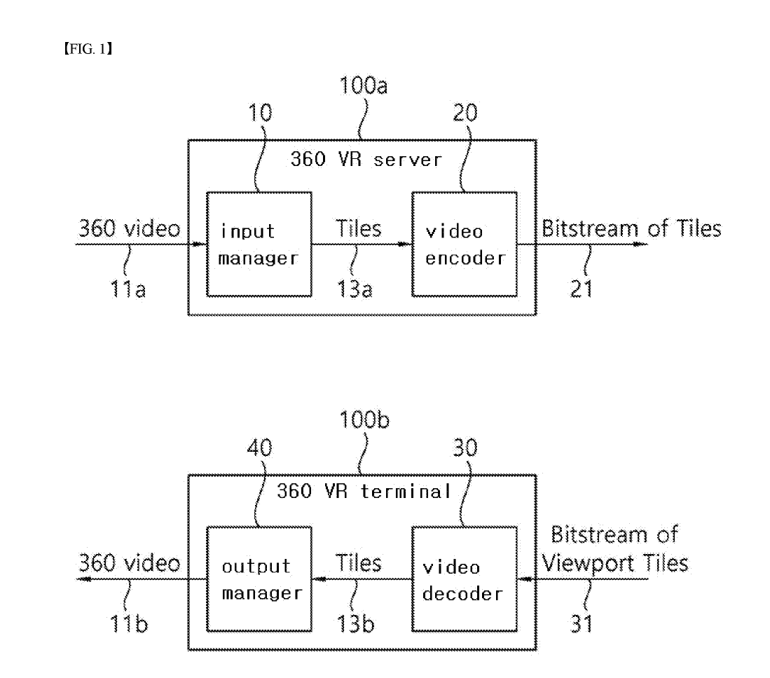

FIG. 1 is a conceptual diagram illustrating tile-based 360 VR video encoding and decoding processes in a 360 VR system according to an embodiment of the present invention.

As shown in FIG. 1, the 360 VR system according to an embodiment of the present invention includes a 360 VR server 100a and a 360 VR terminal 100b. The 360 VR server 100a includes an input manager 10 and a video encoder 20, and the 360 VR terminal 100b includes a video decoder 30 and an output manager 40.

When the 360 VR video 11a is input to the 360 VR server 100a, the input manager 10 of the 360 VR server 100a may spatially divide the input 360 VR video 11a into a plurality of regions. For example, the input manager 10 may divide the 360 VR video 11a into a plurality of tiles and then sequentially transmits at least one tile 13a to the video encoder 20 at a high speed. The video encoder 20 receives at least one tile 13a and generates a bitstream 21 in a unit of tile set.

The video decoder 30 may receive from server bitstream of tile sets for rendering the viewport, decode the received bitstream 31 of the tile sets, and then transmit the decoded tiles 13b to the output manager 40. The output manager 40 is provided such that the decoded tiles 13b may be arranged to configure the viewport of the 360 VR video to allow the viewport to be rendered.

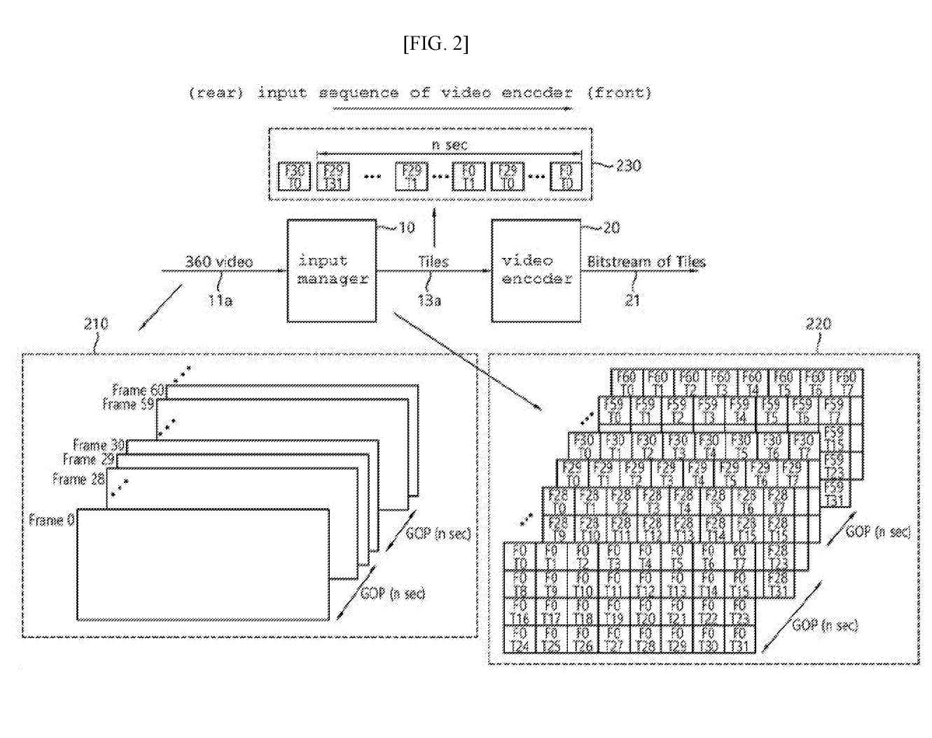

FIG. 2 is a conceptual diagram illustrating in more detail a tile-based 360 VR video encoding process according to an embodiment of the present invention.

Hereinafter, considering that the number of frames in a group of pictures (GOP) is 30 when encoding the video, and a frame consists of 32 spatial regions, i.e., 32 tiles, a tile-based 360 VR video encoding and decoding processes according to embodiments of the present invention will be described. According to an encoding implementation, the GOP may have a value other than 30, and one frame may have tiles of the number other than 32.

Referring to FIG. 2, the first GOP includes 30 frames from frame 0 to frame 29, and the second GOP includes 30 frames from frame 30 to frame 59. Frames included in each GOP may have the same division structure. Here, the division structure may include at least one of the number of divided regions, the position of the divided regions, or the size of the divided regions. The division structure of the frames for each GOP may be set differently. In one example, if the second GOP has a different division structure than the first GOP, information on the updated division structure for the second GOP may be encoded.

It is illustrated in FIG. 2 that each frame in the first GOP F0, F1, F2, . . . F29 and each frame in the second GOP F30, F31, . . . F59 comprise 32 tiles of tiles T0, T1, . . . , and T31. Unlike the illustrated example, the number of tiles included in the frames included in the first GOP and the number of tiles included in the frames included in the second GOP may be set differently. Alternatively, the number of tiles is the same, but the position or size of the tiles may be set differently. Referring back to FIG. 2, the 360 VR video 11a is sequentially input to the input manager 10 in the order of frames F0, F1, . . . , F29, F30, . . . , and F60, as denoted by a reference numeral 210.

The GOP is set when encoding video, in which the input manager 10 may buffer the video according to the GOP. The input manager 10 divides each of frames in GOP (F0, F1, . . . , F29, F30, . . . , and F60) into a unit of a tile and then sequentially transmits the divided tile 13a to the video encoder 20. Each of the tiles may be encoded independently. As an example, motion constraint is applied between tiles so that encoding parameters may not have dependencies between tiles.

The input manager 10 may sequentially input tiles positioned at the same position from the first frame of the GOP to the last frame of the GOP (hereinafter referred to as a tile set or a tile sequence) to the video encoder 20. And, the video encoder may generate bitstreams in a unit of tile set rather a unit of frame. This process is repeated until all the tile sets in the GOP are input, and bitstreams may be generated by the number of tile sets.

In the above process, the video encoder 20 may be set so that the processing time (n sec) in the case where encoding is performed on a frame basis and in the case where encoding is performed on a tile set basis is the same for the frames in the GOP. That is, the input manager 10 sequentially inputs the tile sets in the GOP to the video encoder 20 so that the time (n sec) it takes to process all tiles in the GOP is equal to the time it takes to process all frames in the GOP as denoted by a reference numeral 230 in FIG. 2.

To this end, among encoding parameters of the video encoder 20, the size of the input video 13a of the video encoder 20 may be set as the size of the tile, and the frame rate of the input video 13a of the video encoder 20 is set as a total number of tiles in the GOP (i.e., (frame rate of 360 VR video)×(the number of tiles)). For example, in the example of FIG. 2, considering that a 360 VR video has a size of 3840×2160 and is input at a frame rate of 30 fps, the encoding parameters relating to a size of an input video of the video encoder 20 has a tile size of 480×540 (i.e., the size of the video input to the video encoder 20=the size of the tile) and the encoding parameter relating to a frame rate (frame rate of the input video 13a of the video encoder 20) may has of 960 fps which corresponding to total number of tiles in the GOP. Generally, the smaller the size of the video, the faster the encoding speed. Accordingly, a high-speed processing of a tile is enabled. The frame rate of the input video may be included in the above-described divided structure.

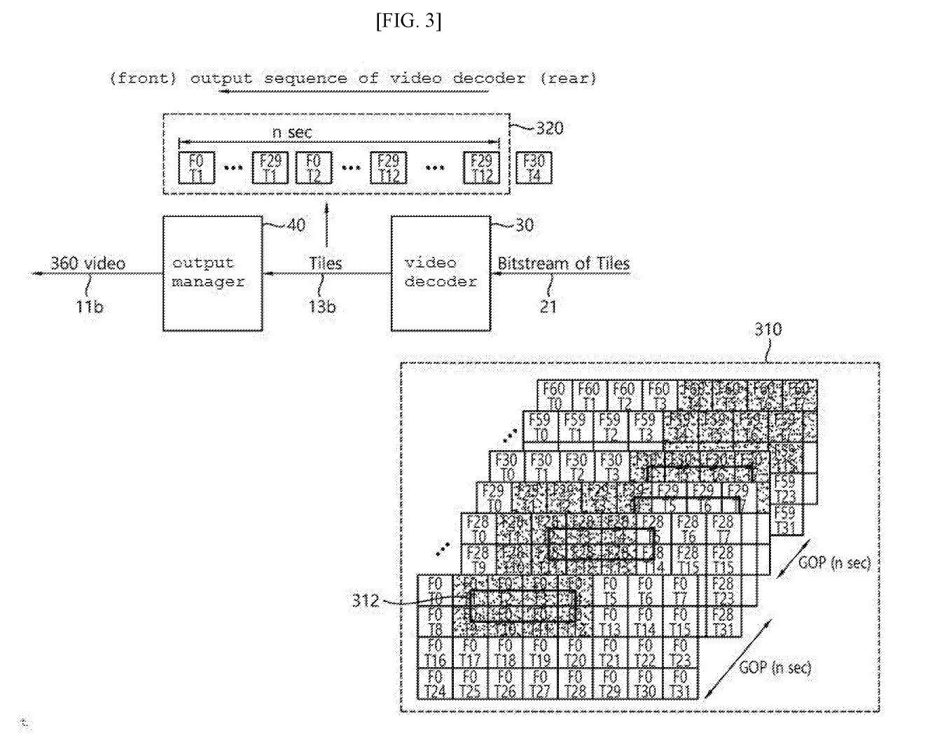

FIG. 3 is a conceptual diagram illustrating in more detail a tile-based 360 VR video decoding process according to an embodiment of the present invention.

Referring to FIG. 3, the video decoder 30 may receive bitstreams of tile set for constructing a viewport from the 360 VR server, and then perform decoding in the reverse order of the above-described encoding. Specifically, the video decoder 30 may receive and decode only the bitstreams of the tile sets necessary for constructing the viewport among the bitstreams of the tile sets.

It is illustrated in FIG. 3 that a viewport of 0th frame illustrated as the rectangle 312 exist over the tiles T1, T2, T3, T4, T9, T10, T11, and T12. Accordingly, the video decoder 30 sequentially receives and decodes tile sets for T1, T2, T3, T4, T9, T10, T11, and T12. The tile set may include co-located tiles in all frames in the GOP (i.e., from the first frame F0 of the GOP to the last frame F29 of the GOP). A rectangular dotted line denoted by a reference numeral 320 in FIG. 3 represents an example in which a set of tiles, corresponding to one GOP and decoded by the video decoder 30, the tiles T1, T2, T3, T4, T9, T10 and T11 included in the viewport region of the first frame is output at the decoder for n sec.

That is, as described above, the video decoder 30 receives and decodes the set of tiles corresponding to the viewport, and sequentially transmits the decoded tiles 13b to the output manager 40.

The output manager 40 is provided such that the decoded tiles 13b are reconstructed as 360 VR video to be rendered. In order to reconstruct the 360 VR video, it is necessary to know the position of each tile in the 360 VR video. The position of each tile in the 360 VR video is acquired using, for example, the spatial relationship description SRD of the MPEG DASH standard.

According to the tile-based 360 VR video encoding and decoding methods according to an embodiment of the present invention, it is possible to provide 360 VR video service only using one video encoder and one video decoder.

If the viewport is not changed while the GOP is being reproduced, efficiency of a system can be improved by selectively receiving bitstreams of tile sets based on the viewport of the first frame of the GOP, as in the example shown in FIG. 3. However, when the viewport is changed by movements of the user's head or eyes while reproducing a GOP, there may be a problem that the changed viewport cannot be completely rendered since the tiles corresponding to the region to be newly included (i.e., regions included to the changed viewport) to construct the changed viewport are not being received. That is, the regions corresponding to the changed viewport cannot be decoded until the next GOP. Therefore, 360 VR video may be interrupted while being reproduced, whereby it is possible to cause inconvenience while watching the 360 VR video.

That is, when the viewport in the first GOP indicated by the reference numeral 312 in FIG. 3 is changed out of the region consisting of tiles T1, T2, T3, T4, T9, T10, T11, and T12 so that new tile(s) corresponding to the changed viewport are needed, there is a problem that the new tile(s) may not be decoded until the next GOP.

According to another embodiment of the present invention, by expanding the number of the video encoder, it is possible to implement 360 VR video service in which 360 VR video reproduction is smooth.

For convenience of explanation, it is assumed that the number of encoders is two in the embodiment described later. It is also within the scope of the present invention to use more than two encoders.

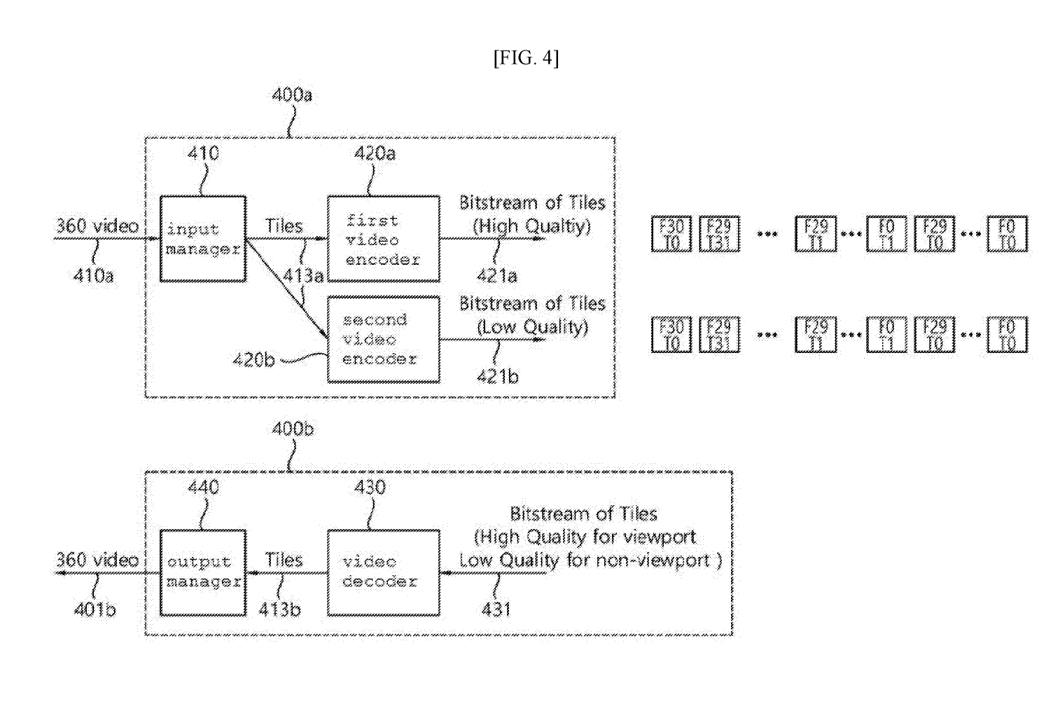

FIG. 4 is a conceptual diagram illustrating a tile-based 360 VR video encoding process using two video encoders according to another embodiment of the present invention;

Referring to FIG. 4, the 360 VR system according to another embodiment of the present invention includes a 360 VR server 400a and a 360 VR terminal 400b. The 360 VR server 400a includes an input manager 410, a first video encoder 420a, and a second video encoder 420b, and the 360 VR terminal 400b includes a video decoder 430 and an output manager 440.

The input manager 410 and the video encoders 420a and 420b operate according to a fast tile-based encoding method described above.

Specifically, when 360 VR video 401a is input to the 360 VR server 400a, the input manager 410 of the 360 VR server 400a spatially divides the inputted 360 VR video 401a into a plurality of tiles 413a, and then sequentially transfers the tiles to the first video encoder 420a and the second video encoder 420b at a high speed. The video encoders 420a and 420b receive the generated one or more tiles 413a to generate bitstreams 421a and 421b of tiles.

The first video encoder 420a and the second video encoder 420b may encode the same video source with different quality. Specifically, the first video encoder 420a generates a high quality bitstream by encoding tiles with a high quality and the second video encoder 420b generates a low quality bitstream by encoding tiles with a low quality.

The video decoder 430 requests the server to send bitstreams of tile sets necessary for rendering the viewport. Here, the video decoder 430 receives and decodes the high quality bitstreams of tile sets 421a for a region corresponding to the viewport and receives and decodes the low quality bitstreams of tile sets 421b for a region other than the viewport.

The video decoder 430 decodes the received tile streams and transfers the decoded tiles 413b to the output manager 440, and the output manager 440 is provided such that the decoded tiles 413b may be arranged to configure the viewport of the 360 VR video and then be rendered.

Accordingly, when the viewport is changed out of the tile region encoded with a high quality due to movements of the user's head or eyes, the 360 VR video is rendered based on the decoding result of the low quality bitstreams of tile sets corresponding to the changed region. In addition, when the next GOP is started the high quality bitstreams of tile set is re-determined based on the changed viewport, whereby it is possible to provide smooth 360 VR video service.

The high quality bitstreams of tile set and the low quality bitstreams of tile set may be implemented in such a manner as to be processed by one video decoder or two video decoders.

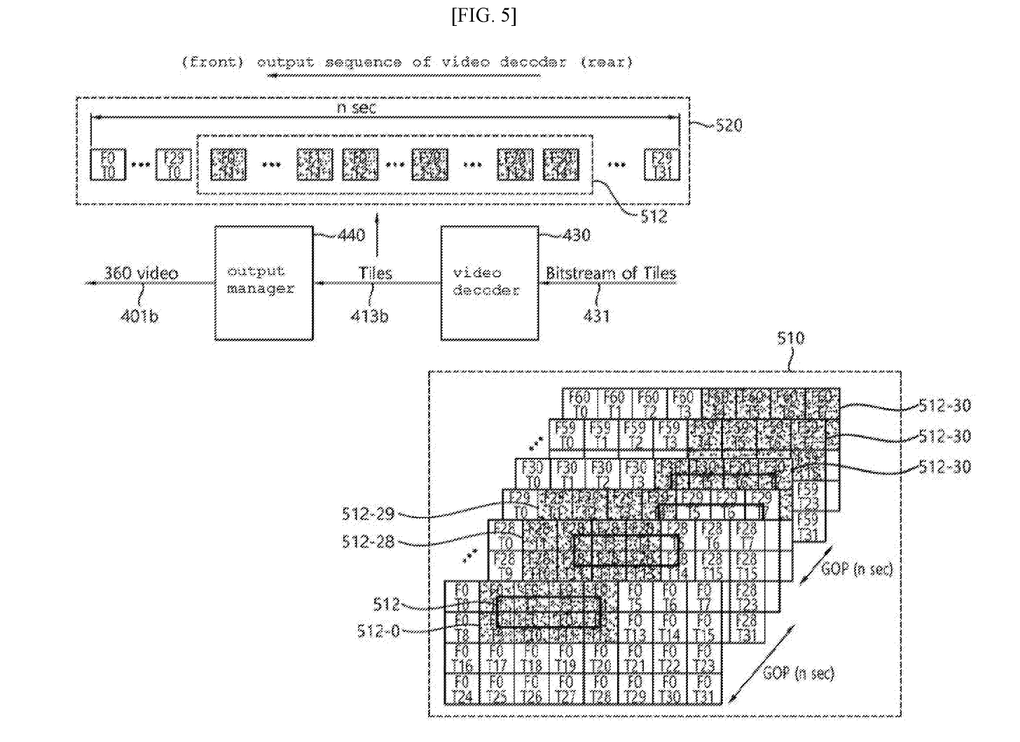

FIG. 5 is a conceptual diagram illustrating a tile-based 360 VR video decoding process using two encoders according to another embodiment of the present invention.

Referring to FIG. 5, frames included in each GOP may have the same division structure. It is illustrated in FIG. 5 that each frames in the first GOP F0, F1, F2, . . . F29 and each frames in the second GOP F30, F31, . . . F59 comprise 32 tiles of tiles T0, T1, . . . , and T31. Unlike the illustrated example, the number of tiles included in the frames included in the first GOP and the number of tiles included in the frames included in the second GOP may be set differently. Alternatively, the number of tiles is the same, but the position or size of the tiles may be set differently.

In decoding the first GOP, the decoder 430 may receive and decode the high-quality tile set bitstreams for the areas 512-0 to 512-29 corresponding to the viewport of the first frame F0. Specifically, the decoder may decode high-quality tile sets of T1, T2, T3, T4, T9, T10, T11 and T12. The decoder 430 may receive and decode the low-quality tile set bitstreams for the remaining region excluding the viewport corresponding area of F0.

Meanwhile, in decoding the second GOP, the decoder 430 may receive and decode the high-quality tile set bitstreams for the areas (512-30 to 512-59) corresponding to the viewport of the first frame F30. Specifically, the decoder 430 may decode high-quality tile sets of T4, T5, T6, T7, T12, T13, T14 and T15. The decoder 430 may receive and decode the low quality tile set bitstreams for the remaining area except for the viewport corresponding area of F30.

The high quality tile portion in the tiles 413b decoded by the video decoder 430 is denoted by a reference numeral 512, corresponding to the high quality tile region for each frame of the GOP described above.

The video decoder 430 has to process all low quality tiles and high quality tiles in the GOP in n seconds as shown in FIG. 5.

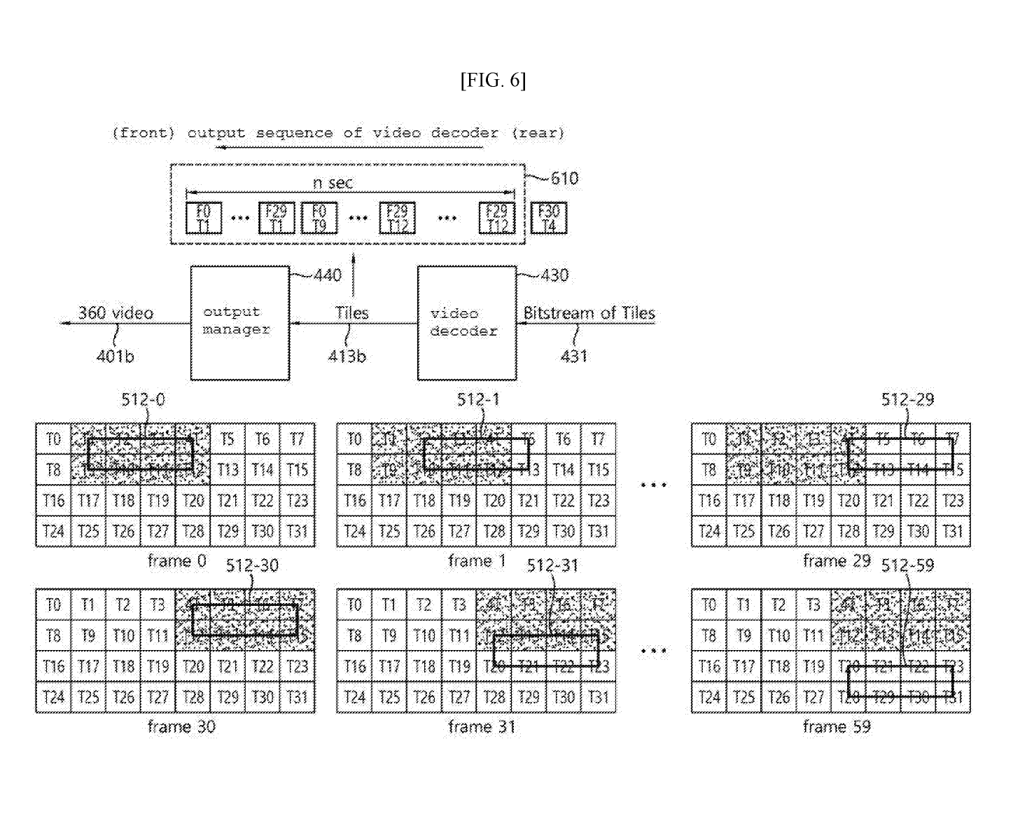

FIG. 6 is a conceptual diagram showing viewport regions in the frames F0, F1, . . . , F29, F30, F31, . . . , and F59 in accordance with movements of the user's head or eyes in the tile-based 360 VR video decoding process of FIG. 5. For example, in FIG. 6, a viewport region 512-0 in the frame F0, a viewport region 512-1 in the frame F1, . . . , a viewport region 512-29 in the frame F29, a viewport region 512-30 in the frame F30, a viewport region 512-30 of the frame F30, a viewport region 512-31 of the frame F31, . . . , and a viewport region 512-59 of the frame F59 are shown.

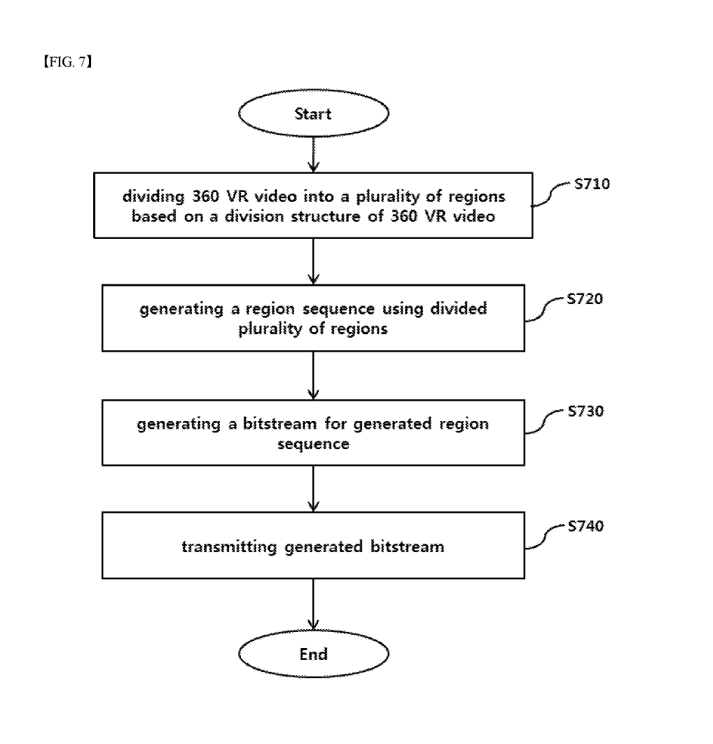

FIG. 7 is a flowchart illustrating a tile-based 360 VR video encoding process in a 360 VR system according to an embodiment of the present invention.

Referring to FIG. 7, a 360 virtual reality (VR) video encoding method according to an embodiment of the present invention includes dividing the 360 VR video into a plurality of regions based on a division structure of the 360 VR video (S710), generating a region sequence using the divided plurality of regions (S720), generating a bitstream for the generated region sequence (S730), and transmitting the generated bitstream (S740).

The region sequence comprises regions having a same position in at least one or more frame included in the 360 VR image.

The region comprises at least one of a tile and a sub-picture.

The division structure of 360 VR image is determined on an unit of a group of pictures (GOP), and wherein the generating the bitstream comprises: generating a bitstream for at least one region sequence included in the GOP.

The generating the bitstream (S730) comprises: repeatedly generating a bitstream for all the region sequences included in the GOP.

The bitstream comprises a first bitstream and a second bitstream generated from at least one region sequence included in the GOP, wherein the first bitstream and the second bitstream have different image quality.

The first bitstream is higher in image quality than the second bitstream. Also, the first bitstream is generated using a first video encoder, wherein the second bitstream is generated using a second video encoder different from the first video encoder.

The division structure of the 360 VR image comprises at least one of a number of the region, a position of the region, a size of the region and a frame rate of the region.

The frame rate is set that a time for generating a bitstream for all the region sequences included in the GOP is equal to a time for generating a bitstream for all frames included in the GOP.

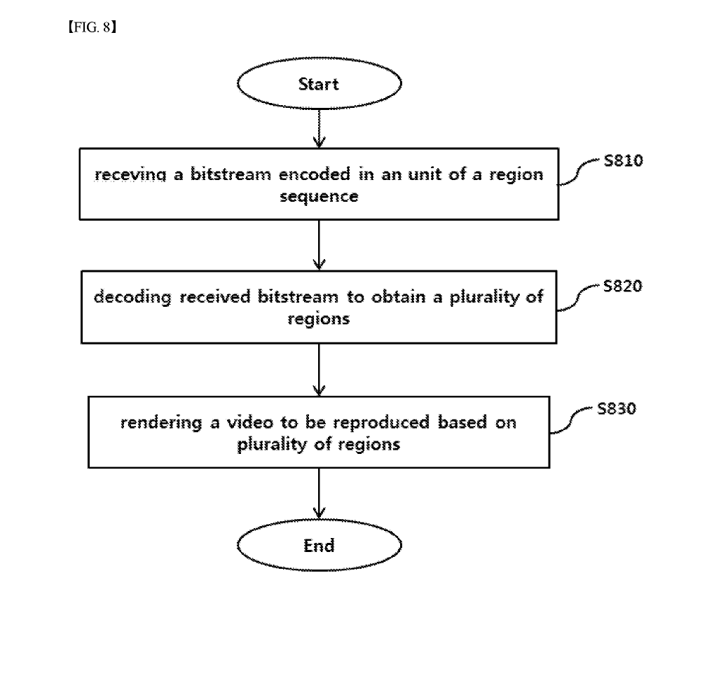

FIG. 8 is a flowchart illustrating a tile-based 360 VR video decoding process in a 360 VR system according to an embodiment of the present invention.

Referring to FIG. 8, a 360 virtual reality (VR) video decoding method according to an embodiment of the present invention includes receiving a bitstream encoded in an unit of a region sequence (S810), decoding the received bitstream to obtain a plurality of regions (S820), and rendering a video to be reproduced based on the plurality of regions (S830).

The region sequence comprises regions having a same position in at least one or more frame included in the 360 VR image.

The region comprises at least one of a tile and a sub-picture.

The bitstream comprises at least two bitstreams having different image qualities, a viewport region is received a bitstream having a higher image quality than remaining regions excluding the viewport region.

The viewport region is determined based on a first frame of frames included in a group of picture (GOP). Also, the viewport region is updated in an unit of a GOP.

At least two bitstreams having different image qualities are decoded by one video decoder.

The rendering the video to be reproduced (S830) comprises: arranging the plurality of regions in an unit of the region sequence; wherein the arranging the plurality of regions comprises: arranging the plurality of regions in the same position as when inputting to a video encoder.

The arranging the plurality of regions comprises: repeatedly performing all the region sequences included in the GOP until the region sequence is arranged.

a 360 virtual reality (VR) video decoding method according to an embodiment of the present invention includes

The 360 virtual reality (VR) video decoding method further comprises when the viewport region is changed, receiving a bitstream having a higher image quality that the remaining regions excluding the viewport region for the changed viewport region, based on at least one of the changed position and the GOP information.

The plurality of regions are divided from the 360 VR image based on a division structure of the 360 VR image, wherein the division structure of the 360 VR image comprises at least one of a number of the region, a position of the region, a size of the region and a frame rate of the region.

The frame rate is set that a time for generating a bitstream for all the region sequences included in a group of picture (GOP) is equal to a time for generating a bitstream for all frames included in the GOP.

Although exemplary methods of the present disclosure are described as a series of operation steps for clarity of a description, the present disclosure is not limited to the sequence or order of the operation steps described above. The operation steps may be simultaneously performed, or may be performed sequentially but in different order. In order to implement the method of the present disclosure, additional operation steps may be added and/or existing operation steps may be eliminated or substituted.

Various embodiments of the present disclosure are not presented to describe all of available combinations but are presented to describe only representative combinations. Steps or elements in various embodiments may be separately used or may be used in combination.

In addition, various embodiments of the present disclosure may be embodied in the form of hardware, firmware, software, or a combination thereof. When the present disclosure is embodied in a hardware component, it may be, for example, an application specific integrated circuit (ASIC), a digital signal processor (DSP), a digital signal processing device (DSPD), a programmable logic device (PLD), a field programmable gate array (FPGA), a general processor, a controller, a microcontroller, a microprocessor, etc.

The scope of the present disclosure includes software or machine-executable instructions (for example, operating systems (OS), applications, firmware, programs) that enable methods of various embodiments to be executed in an apparatus or on a computer, and a non-transitory computer-readable medium storing such software or machine-executable instructions so that the software or instructions can be executed in an apparatus or on a computer.

1. A method for encoding a 360 virtual reality (VR), the method comprising:
dividing the 360 VR video into a plurality of regions based on a division structure of the 360 VR video;
generating a region sequence using the divided plurality of regions;
generating a bitstream for the generated region sequence; and
transmitting the generated bitstream,
wherein the region sequence comprises regions having a same position in at least one or more frame included in the 360 VR image.

2. The method of according to claim 1, wherein the region comprises at least one of a tile and a sub-picture.

3. The method of according to claim 1,
wherein the division structure of 360 VR image is determined on an unit of a group of pictures (GOP),
wherein the generating the bitstream comprises:
generating a bitstream for at least one region sequence included in the GOP.

4. The method according to claim 3,
wherein the generating the bitstream comprises:
repeatedly generating a bitstream for all the region sequences included in the GOP.

5. The method according to claim 4,
wherein the bitstream comprises a first bitstream and a second bitstream generated from at least one region sequence included in the GOP,
wherein the first bitstream and the second bitstream have different image quality.

6. The method according to claim 5,
wherein the first bitstream is higher in image quality than the second bitstream.

7. The method according to claim 5,
wherein the first bitstream is generated using a first video encoder,
wherein the second bitstream is generated using a second video encoder different from the first video encoder.

8. The method according to claim 1,
wherein the division structure of the 360 VR image comprises at least one of a number of the region, a position of the region, a size of the region and a frame rate of the region.

9. The method according to claim 8,
wherein the frame rate is set that a time for generating a bitstream for all the region sequences included in the GOP is equal to a time for generating a bitstream for all frames included in the GOP.

10. A method for decoding a 360 virtual reality (VR) video, the method comprising:
receiving a bitstream encoded in an unit of a region sequence;
decoding the received bitstream to obtain a plurality of regions; and
rendering a video to be reproduced based on the plurality of regions,
wherein the region sequence comprises regions having a same position in at least one or more frame included in the 360 VR image.

11. The method of according to claim 10, wherein the region comprises at least one of a tile and a sub-picture.

12. The method according to claim 10,
wherein the bitstream comprises at least two bitstreams having different image qualities,
a viewport region is received a bitstream having a higher image quality than remaining regions excluding the viewport region.

13. The method according to claim 12,
wherein the viewport region is determined based on a first frame of frames included in a group of picture (GOP).

14. The method according to claim 12,
wherein the viewport region is updated in an unit of a GOP.

15. The method according to claim 12,
wherein at least two bitstreams having different image qualities are decoded by one video decoder.

16. The method according to claim 10,
wherein the rendering the video to be reproduced comprises:
arranging the plurality of regions in an unit of the region sequence;
wherein the arranging the plurality of regions comprises:
arranging the plurality of regions in the same position as when inputting to a video encoder.

17. The method according to claim 16,
wherein the arranging the plurality of regions comprises:
repeatedly performing all the region sequences included in the GOP until the region sequence is arranged.

18. The method according to claim 12, further comprising:
when the viewport region is changed,
receiving a bitstream having a higher image quality that the remaining regions excluding the viewport region for the changed viewport region, based on at least one of the changed position and the GOP information.

19. The method according to claim 10,
wherein the plurality of regions are divided from the 360 VR image based on a division structure of the 360 VR image,
wherein the division structure of the 360 VR image comprises at least one of a number of the region, a position of the region, a size of the region and a frame rate of the region.

20. The method according to claim 19,
wherein the frame rate is set that a time for generating a bitstream for all the region sequences included in a group of picture (GOP) is equal to a time for generating a bitstream for all frames included in the GOP.
